(19) United States
(12) Patent Application Publication
(10) Pub. No.: US 2026/0002030 A1
(43) Pub. Date: Jan. 1, 2026

(54) CONDUCTIVE POLYMER SOLUTION AND APPLICATION OF SAME

(71) Applicant: TOSOH CORPORATION, Yamaguchi (JP)

(72) Inventors: Kazuki KUDO, Yamaguchi (JP); Hirokazu YANO, Yamaguchi (JP)

(73) Assignee: TOSOH CORPORATION, Yamaguchi (JP)

(21) Appl. No.: 19/105,444

(22) PCT Filed: Aug. 25, 2023
(86) PCT No.: PCT/JP2023/030637

§ 371 Date: Feb. 21, 2025

(30) Foreign Application Priority Data
Aug. 29, 2022 (JP) 2022-136074
Mar. 29, 2023 (JP) 2023-054283

(51) Int. Cl. C09D 5/24; C09D 7/65; C09D 165/00; H01G 9/00; H01G 9/042

(52) U.S. Cl. CPC C09D 5/24; C09D 7/65; C09D 165/00; H01G 9/0029; H01G 9/042

(57) ABSTRACT

Provided is an electrically conductive polymer solution which can provide an electrolytic capacitor having a high capacity and exhibiting a low ESR characteristic. An electrically conductive polymer solution is used which contains: 0.01 to 10% by mass of polythiophene (A) including at least one structural unit selected from the group consisting of a structural unit represented by a general formula (1) below and a structural unit represented by a general formula (2) below; 0.001 to 20% by mass of an epoxy compound (B) having at least two epoxy groups; and water, and in which a pH is 1.5 to 5.0,

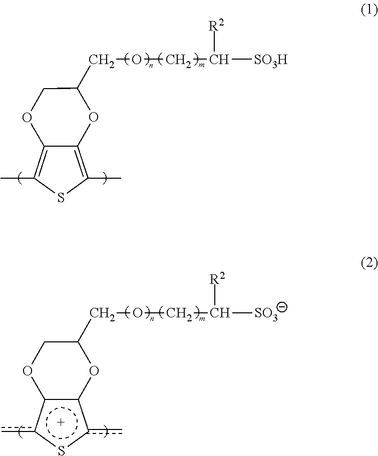

where R² represents a hydrogen atom, a methyl group, an ethyl group, a linear or branched alkyl group having 3 to 6 carbon atoms, or a fluorine atom, m represents an integer of 1 to 10, and n represents 0 or 1.

### TECHNICAL FIELD

The present invention relates to an electrically conductive polymer solution, an electrically conductive polymer film obtained by drying the electrically conductive polymer solution, and application thereof.

### BACKGROUND ART

As a type of electrolytic capacitor, an electrically conductive polymer capacitor in which an electrically conductive polymer is used as an electrolyte is known.

As an electrically conductive polymer aqueous solution for producing such an electrically conductive polymer capacitor, an electrically conductive polymer aqueous solution containing a polythiophene-based self-doped electrically conductive polymer and an oxazoline-based compound (e.g., Patent Literature 1), and the like have been reported.

### CITATION LIST

### Patent Literature

### Patent Literature 1

Japanese Patent Application Publication Tokukai No. 2020-7519

### SUMMARY OF INVENTION

### Technical Problem

An aspect of the present invention provides an electrically conductive polymer solution which makes it possible to provide an electrolytic capacitor which has a high capacity and exhibits a low equivalent series resistance (ESR) characteristic.

### Solution to Problem

As a result of diligent study, the inventors of the present invention have found that an electrically conductive polymer solution described below can attain the above object, and thus have accomplished the present invention.

That is, an aspect of the present invention relates to an electrically conductive polymer solution as described below, an electrically conductive polymer film, and an electrolytic capacitor using the electrically conductive polymer solution.

An electrically conductive polymer solution, containing: 0.01% by mass to 10% by mass of polythiophene (A) including at least one structural unit which is selected from the group consisting of a structural unit represented by a general formula (1) below and a structural unit represented by a general formula (2) below; 0.001% by mass to 20% by mass of an epoxy compound (B) having at least two epoxy groups; and water, a pH of the electrically conductive polymer solution being 1.5 to 5.0,

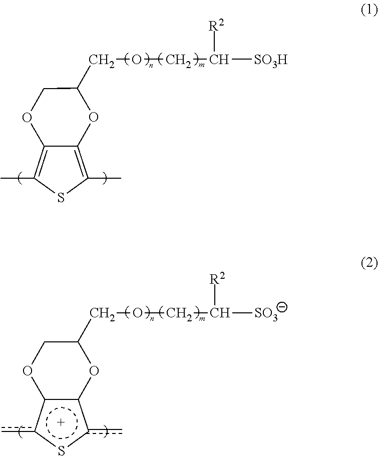

in the general formulae (1) and (2), R² represents a hydrogen atom, a methyl group, an ethyl group, a linear or branched alkyl group having 3 to 6 carbon atoms, or a fluorine atom, m represents an integer of 1 to 10, and n represents 0 or 1.

### Advantageous Effects of Invention

According to an aspect of the present invention, it is possible to provide an electrically conductive polymer solution which makes it possible to provide an electrolytic capacitor which has a high capacity and exhibits a low ESR characteristic.

### DESCRIPTION OF EMBODIMENTS

The following description will discuss details of an embodiment of the present invention. Note that a numerical range “A to B” herein means “not less (lower) than A and not more (higher) than B” unless otherwise stated.

In the field of electrolytic capacitors, an electrolytic capacitor which has a long lifetime and a high capacity, and exhibits a low ESR characteristic is strongly demanded in accordance with an increase in speed and an increase in frequency of electronic equipment.

An electrically conductive polymer capacitor exhibits a lower ESR characteristic, a low temperature characteristic, and a characteristic of excellent stability, as compared with a type of capacitor in which an electrically conductive polymer is not used as an electrolyte.

From the viewpoint of chemical stability, as an electrically conductive polymer, a polythiophene-based electrically conductive polymer is useful in practical use. Under the circumstances, an improvement has been demanded for the electrically conductive polymer composition disclosed in Patent Literature 1, for the purpose of further improving capacitor characteristics (e.g., a capacity level of capacitors).

Specifically, as one of improvement measures, a method was assumed in which a liquid property of an electrically conductive polymer composition is made acidic. Meanwhile, in a case where the liquid property of the electrically conductive polymer aqueous solution in Patent Literature 1 is made acidic, an oxazoline group-containing water-soluble polymer aggregates. Therefore, there was a problem that physical properties (e.g., low ESR characteristic, and the like) essentially demanded for an electrically conductive polymer composition for a capacitor are impaired, and thus improvement was not easy. Moreover, in a case where the liquid property of the electrically conductive polymer aqueous solution in Patent Literature 1 is made acidic, an oxazoline group-containing water-soluble polymer is likely to aggregate. Therefore, the electrically conductive polymer composition disclosed in Patent Literature 1 has a drawback of being difficult to use as an electrolyte of a hybrid capacitor. Furthermore, although an electrolytic capacitor obtained using the electrically conductive polymer composition disclosed in Patent Literature 1 has a low initial surface resistance value (low ESR), there is room for improvement in heat resistance and durability (i.e., a characteristic of making it possible to maintain a low ESR for a long period of time).

An object of the present embodiment is to provide an electrically conductive polymer solution which makes it possible to provide an electrolytic capacitor which has a high capacity and exhibits a low ESR characteristic. Specifically, the present embodiment relates to an electrically conductive polymer solution that is characterized by (i) containing polythiophene which includes a specific structural unit, a compound which has a specific number of epoxy groups, and water, and (ii) exhibiting a specific pH. Moreover, the present embodiment relates to a method for producing an electrically conductive polymer film, the method including the steps of: applying the electrically conductive polymer solution to a base material; and drying the electrically conductive polymer solution. Furthermore, the present embodiment relates to a method for producing an electrolytic capacitor, the method including the steps of: covering, with the electrically conductive polymer solution, a surface of a dielectric oxide film which is formed in a positive electrode body; and drying the electrically conductive polymer solution by heating. By having the above features, the present embodiment brings about an advantage of making it possible to provide an electrically conductive polymer solution which can provide an electrolytic capacitor that can maintain a high capacity and a low ESR characteristic for a long time.

In this specification, the term “electrolytic capacitor” is intended to be a capacitor including a dielectric layer constituted by an oxide film of a metal (e.g., aluminum, or the like), and includes a solid electrolytic capacitor and a hybrid capacitor. In this specification, the solid electrolytic capacitor is intended to be a capacitor in which an electrolyte is a solid. In this specification, the hybrid capacitor is intended to be a capacitor in which an electrolyte is a hybrid electrolyte in which an electrically conductive polymer is fused with an electrolytic solution.

In this specification, a “solid electrolytic capacitor” is sometimes referred to as a “solid electrolytic capacitor element”, and a “hybrid capacitor” is sometimes referred to as a “hybrid capacitor element”.

The present embodiment is an electrically conductive polymer solution, containing: 0.01% by mass to 10% by mass of polythiophene (A) including at least one structural unit which is selected from the group consisting of a structural unit represented by a general formula (1) below and a structural unit represented by a general formula (2) below; 0.001% by mass to 20% by mass of an epoxy compound (B) having at least two epoxy groups; and water, a pH of the electrically conductive polymer solution being 1.5 to 5.0,

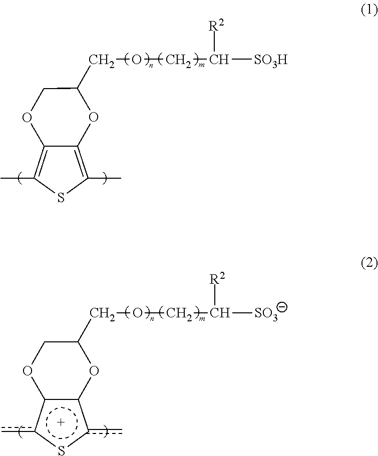

in the general formulae (1) and (2), R² represents a hydrogen atom, a methyl group, an ethyl group, a linear or branched alkyl group having 3 to 6 carbon atoms, or a fluorine atom, m represents an integer of 1 to 10, and n represents 0 or 1.

In this specification, a composition containing the above polythiophene (A) and the epoxy compound (B) is referred to also as an electrically conductive polymer composition. In other words, the above electrically conductive polymer solution is a solution containing the electrically conductive polymer composition.

The linear or branched alkyl group having 3 to 6 carbon atoms are not particularly limited, and examples thereof include an n-propyl group, an isopropyl group, an n-butyl group, an isobutyl group, a sec-butyl group, a tert-butyl group, an n-pentyl group, an isopentyl group, a neopentyl group, a tert-pentyl group, a cyclopentyl group, an n-hexyl group, a 2-ethylbutyl group, a cyclohexyl group, and the like.

From the viewpoint of film formation property, R² above is preferably a hydrogen atom, a methyl group, an ethyl group, or a fluorine atom.

In the general formulae (1) and (2), m represents an integer of 1 to 10. From the viewpoint of film formation property, m is preferably an integer of 1 to 6, more preferably an integer of 1 to 4, more preferably 2 or 3.

In the general formulae (1) and (2), n represents 0 or 1. From the viewpoint of excellence in electrical conductivity, n is preferably 1.

The structural unit represented by the formula (2) indicates a doped state of the structural unit represented by the formula (1).

Dopants that each cause an insulator-metal transition by doping are classified into acceptors and donors. The former enters near a polymer chain of an electrically conductive polymer by doping, and deprives a π-electron from a conjugate system of a main chain. As a result, a positive charge (hole) is injected on the main chain, and therefore the acceptor is referred to also as a p-type dopant. The latter is referred to also as an n-type dopant, because the donor on the contrary provides an electron to the conjugate system of the main chain, and this electron moves in the conjugate system of the main chain.

The dopant in the present embodiment is a sulfo group or a sulfonate group that is linked in a polymer molecule by a covalent bond, and is a p-type dopant. A polymer that expresses electrical conductivity without external addition of a dopant is referred to as a self-doped polymer.

A pH of the electrically conductive polymer solution in accordance with the present embodiment is 1.5 to 5.0, preferably 2.0 to 4.0, more preferably 2.5 to 3.5, further preferably 2.75 to 3.25, particularly preferably 3.0. The configuration has an advantage of making it possible to provide an electrolytic capacitor which exhibits a low ESR characteristic. Note that the pH of the electrically conductive polymer solution can be controlled by a type and a contained amount of a compound (D) (described later) with which an ion pair is formable with a sulfonic acid group.

The polythiophene (A) in the present embodiment can be produced by polymerizing a thiophene monomer represented by a general formula (4) below in water or an alcohol solvent in the presence of an oxidant, and then carrying out an acid treatment as necessary.

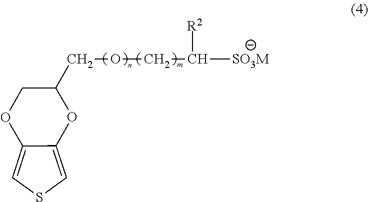

In the general formula (4), M represents a hydrogen ion or a metal ion. R² represents a hydrogen atom, a methyl group, an ethyl group, a linear or branched alkyl group having 3 to 6 carbon atoms, or a fluorine atom, m represents an integer of 1 to 10, and n represents 0 or 1.

The metal ion represented by M in the general formula (4) is not particularly limited, and examples thereof include a transition metal ion, a noble metal ion, a nonferrous metal ion, an alkali metal ion (e.g., an Li ion, an Na ion, a K ion), an alkaline-earth metal ion, and the like.

In a case where a polymer obtained after polymerization of the thiophene monomer represented by the general formula (4) is a metal salt, it is possible to convert M into a hydrogen ion by subjecting the resulting metal salt polymer to an acid treatment.

The thiophene monomer represented by the general formula (4) is not particularly limited, and specific examples thereof include 6-(2,3-dihydro-thieno[3,4-b][1,4]dioxin-2-yl)hexane-1-sulfonic acid, sodium 6-(2,3-dihydro-thieno[3,4-b][1,4]dioxin-2-yl)hexane-1-sulfonate, lithium 6-(2,3-dihydro-thieno[3,4-b][1,4]dioxin-2-yl)hexane-1-sulfonate, potassium 6-(2,3-dihydro-thieno[3,4-b][1,4]dioxin-2-yl)hexane-1-sulfonate, 8-(2,3-dihydro-thieno[3,4-b][1,4]dioxin-2-yl)octane-1-sulfonic acid, sodium 8-(2,3-dihydro-thieno[3,4-b][1,4]dioxin-2-yl)octane-1-sulfonate, potassium 8-(2,3-dihydro-thieno[3,4-b][1,4]dioxin-2-yl)octane-1-sulfonate, sodium 3-[(2,3-dihydrothieno[3,4-b]-[1,4]dioxin-2-yl)methoxy]-1-propanesulfonate, potassium 3-[(2,3-dihydrothieno[3,4-b]-[1,4]dioxin-2-yl)methoxy]-1-propanesulfonate, sodium 3-[(2, 3-dihydrothieno[3,4-b]-[1,4]dioxin-2-yl)methoxy]-1-methyl-1-propanesulfonate, sodium 3-[(2,3-dihydrothieno[3,4-b]-[1,4]dioxin-2-yl)methoxy]-1-ethyl-1-propanesulfonate, sodium 3-[(2,3-dihydrothieno[3,4-b]-[1,4]dioxin-2-yl)methoxy]-1-propyl-1-propanesulfonate, sodium 3-[(2,3-dihydrothieno[3,4-b]-[1,4]dioxin-2-yl)methoxy]-1-butyl-1-propanesulfonate, sodium 3-[(2,3-dihydrothieno[3,4-b]-[1,4]dioxin-2-yl)methoxy]-1-pentyl-1-propanesulfonate, sodium 3-[(2,3-dihydrothieno[3,4-b]-[1,4]dioxin-2-yl)methoxy]-1-hexyl-1-propanesulfonate, sodium 3-[(2,3-dihydrothieno[3,4-b]-[1,4]dioxin-2-yl)methoxy]-1-isopropyl-1-propanesulfonate, sodium 3-[(2,3-dihydrothieno[3,4-b]-[1,4]dioxin-2-yl)methoxy]-1-isobutyl-1-propanesulfonate, sodium 3-[(2,3-dihydrothieno[3,4-b]-[1,4]dioxin-2-yl)methoxy]-1-isopentyl-1-propanesulfonate, sodium 3-[(2,3-dihydrothieno[3,4-b]-[1,4]dioxin-2-yl)methoxy]-1-fluoro-1-propanesulfonate, potassium 3-[(2,3-dihydrothieno[3,4-b]-[1,4]dioxin-2-yl)methoxy]-1-methyl-1-propanesulfonate, 3-[(2,3-dihydrothieno[3,4-b]-[1,4]dioxin-2-yl)methoxy]-1-methyl-1-propanesulfonate, ammonium 3-[(2,3-dihydrothieno[3,4-b]-[1,4]dioxin-2-yl)methoxy]-1-methyl-1-propanesulfonate, triethylammonium 3-[(2,3-dihydrothieno[3,4-b]-[1,4]dioxin-2-yl)methoxy]-1-methyl-1-propanesulfonate, sodium 4-[(2,3-dihydrothieno[3,4-b]-[1,4]dioxin-2-yl)methoxy]-1-butanesulfonate, potassium 4-[(2,3-dihydrothieno[3,4-b]-[1,4]dioxin-2-yl)methoxy]-1-butanesulfonate, sodium 4-[(2,3-dihydrothieno[3,4-b]-[1,4]dioxin-2-yl)methoxy]-1-methyl-1-butanesulfonate, potassium 4-[(2,3-dihydrothieno[3,4-b]-[1,4]dioxin-2-yl)methoxy]-1-methyl-1-butanesulfonate, sodium 4-[(2,3-dihydrothieno[3,4-b]-[1,4]dioxin-2-yl)methoxy]-1-fluoro-1-butanesulfonate, potassium 4-[(2,3-dihydrothieno[3,4-b]-[1,4]dioxin-2-yl)methoxy]-1-fluoro-1-butanesulfonate, and the like.

An electric conductivity of the polythiophene (A) in the present embodiment is not particularly limited, and is preferably 10 S/cm or more as an electric conductivity in the form of film.

Note that, as the polythiophene (A) in the present embodiment, it is possible to use one which is synthesized based on known information.

In the electrically conductive polymer solution in accordance with the present embodiment, a contained amount of the polythiophene (A) which includes at least one structural unit selected from the group consisting of a structural unit represented by the general formula (1) and a structural unit represented by the general formula (2) is 0.01% by mass to 10% by mass. In order to provide an electrolytic capacitor which excels in having low ESR, the contained amount is preferably 0.05% by mass to 8% by mass, more preferably 0.1% by mass to 7% by mass.

The epoxy compound (B) is not particularly limited, and is, for example, preferably a compound in which one molecule of polyhydric alcohol and at least two molecules of alcohol having one epoxy group are linked to each other by an ether bond, and more preferably a compound in which one molecule of polyhydric alcohol and two molecules of alcohol having one epoxy group are linked to each other by an ether bond. Such a configuration has an advantage of making it possible to provide an electrolytic capacitor which exhibits a low ESR characteristic. The epoxy compound (B) is preferably a compound containing no silicon atom.

The polyhydric alcohol is not particularly limited. In order to provide an electrolytic capacitor which exhibits a low ESR characteristic, the polyhydric alcohol is, for example, preferably monohydric to pentahydric alcohol, more preferably monohydric to trihydric alcohol, further preferably dihydric alcohol.

The alcohol having an epoxy group is not particularly limited. In order to provide an electrolytic capacitor which exhibits a low ESR characteristic, the alcohol having an epoxy group is, for example, preferably glycidyl alcohol.

The above epoxy compound (B) is not particularly limited, and examples thereof include ethyleneglycol diglycidyl ether, glycerol diglycidyl ether, polyethyleneglycol diglycidyl ether, polypropyleneglycol diglycidyl ether, resorcinolglycidyl ether, neopentylglycol diglycidyl ether, 1,6-hexanedioldiglycidyl ether, 1,4-butanedioldiglycidyl ether, bisphenol A diglycidyl ether, sorbitol polyglycidyl ether, glycerol polyglycidyl ether, trimethylolpropane polyglycidyl ether, diglycerol polyglycidyl ether, polyglycerol polyglycidyl ether, and the like. The epoxy compound (B) used in the present embodiment can be used alone, or two or more of these can be used in combination. Note that a commercially available product can be used as it is as the epoxy compound (B). Alternatively, a product which has been produced based on a commonly known method can be used as the epoxy compound (B).

The above epoxy compound (B) is not particularly limited, and is preferably one or more selected from the group consisting of ethyleneglycol diglycidyl ether, glycerol diglycidyl ether, sorbitol polyglycidyl ether, and diglycerol polyglycidyl ether. In order to provide an electrolytic capacitor which exhibits a low ESR characteristic, the epoxy compound (B) is more preferably sorbitol polyglycidyl ether.

In the electrically conductive polymer solution in accordance with the present embodiment, a contained amount of the epoxy compound (B) is preferably 0.001% by mass to 20% by mass. In order to provide an electrolytic capacitor which has a high capacity and exhibits a low ESR characteristic, the contained amount of the epoxy compound (B) is more preferably 0.01% by mass to 20% by mass, more preferably 0.1% by mass to 20% by mass, more preferably 0.1% by mass to 15% by mass, more preferably 0.5% by mass to 10% by mass, further preferably 0.5% by mass to 5% by mass, particularly preferably 0.5% by mass to 3% by mass.

In order to provide an electrolytic capacitor which has a high capacity and exhibits a low ESR characteristic, the contained amount of the epoxy compound (B) relative to 1 part by mass of the polythiophene (A) is preferably 0.1 parts by mass to 15 parts by mass, more preferably 0.5 parts by mass to 10 parts by mass, further preferably 0.5 parts by mass to 5 parts by mass, particularly preferably 0.5 parts by mass to 3 parts by mass.

In the electrically conductive polymer solution in accordance with the present embodiment, a weight average molecular weight of a polyacrylic acid (C) is not particularly limited, and is preferably 100 to 1000000, more preferably 1000 to 500000, further preferably 2000 to 100000, particularly preferably 5000 to 50000. The configuration has an advantage of making it possible to provide an electrolytic capacitor which exhibits a low ESR characteristic.

In the electrically conductive polymer solution in accordance with the present embodiment, a contained amount of the polyacrylic acid (C) is preferably 0.001% by mass to 20% by mass. In order to provide an electrolytic capacitor which exhibits a low ESR characteristic, the contained amount of the polyacrylic acid (C) is more preferably 0.01% by mass to 20% by mass, further preferably 0.1% by mass to 20% by mass.

The contained amount of the polyacrylic acid (C) relative to 1 part by mass of the polythiophene (A) is preferably 0.1 parts by mass to 10 parts by mass, more preferably 0.2 parts by mass to 8 parts by mass, further preferably 0.3 parts by mass to 6 parts by mass. The configuration has an advantage of making it possible to provide an electrolytic capacitor which exhibits a low ESR characteristic.

The above compound (D) with which an ion pair is formable with a sulfonic acid group is not particularly limited, and examples thereof include an alkali metal compound, ammonia, an organic amine compound, and quaternary ammonium salt. These compounds each react with a sulfonic acid group in the above polythiophene (A) to form alkali metal ion salt, ammonium ion salt, organic ammonium ion salt, and quaternary ammonium ion salt of the polythiophene (A).

The above alkali metal compound is not particularly limited, and examples thereof include alkali metal salt compounds (e.g., lithium chloride, potassium chloride, sodium chloride, rubidium chloride, cesium chloride, lithium bromide, potassium bromide, sodium bromide, rubidium bromide, cesium bromide, and the like), and alkali metal hydroxides (e.g., lithium hydroxide, potassium hydroxide, sodium hydroxide, rubidium hydroxide, cesium hydroxide, and the like).

By introducing the above alkali metal compound into the electrically conductive polymer solution in accordance with the present embodiment, it is possible to prepare an alkali metal ion salt of the above polythiophene (A). The above alkali metal ion is not particularly limited, and examples thereof include a lithium ion, a potassium ion, a sodium ion, a rubidium ion, and a cesium ion.

The above organic amine compound is not particularly limited, and examples thereof include primary, secondary, and tertiary organic amine compounds each having 1 to 30 carbon atoms in total. More specific examples of the organic amine compound include methylamine, dimethylamine, trimethylamine, ethylamine, triethylamine, normal-propylamine, isopropylamine, normal-butylamine, hexylamine, ethanolamine, dimethylaminoethanol, methylaminoethanol, diethanolamine, N-methyldiethanolamine, triethanolamine, 3-amino-1,2-propanediol, 3-methylamino-1,2-propanediol, 3-dimethylamino-1,2-propanediol, 2-amino-2-hydroxymethyl-1,3-propanediol, 1,4-butanediamine, triisobutylamine, triisopentylamine, triisooctylamine, imidazole, N-methylimidazole, 1,2-dimethylimidazole, pyridine, picoline, lutidine, and the like.

By introducing the above organic amine compound into the electrically conductive polymer solution in accordance with the present embodiment, the organic amine compound reacts with the above polythiophene (A) to be an organic ammonium ion, and thus an organic ammonium ion salt of the polythiophene (A) is prepared. The above organic ammonium ion is not particularly limited, and examples thereof include primary, secondary, and tertiary organic ammonium ions each having 1 to 30 carbon atoms in total. More specific examples of the organic ammonium ion include methylammonium, dimethylammonium, trimethylammonium, ethylammonium, triethylammonium, normal-propylammonium, isopropylammonium, normal butylammonium, hexylammonium, 2-hydroxyethylammonium, N,N-dimethyl-N-(2-hydroxyethyl)ammonium, N-methyl-N-(2-hydroxyethyl)ammonium, di(2-hydroxyethyl)ammonium, N-methyl-N,N-di(2-hydroxyethyl)ammonium, N,N,N-tri(2-hydroxyethyl)ammonium, 2,3-dihydroxypropylammonium, N-methyl-N-(2,3-dihydroxypropyl)ammonium, N,N-dimethyl-N-(2,3-dihydroxypropyl)ammonium, 1,4-butanediammonium, triisopentylammonium, triisobutylammonium, triisooctylammonium, an imidazole cation, an N-methylimidazole cation, a 1,2-dimethylimidazole cation, a pyridinium ion, a picolinium ion, and a lutidinium ion.

The above quaternary ammonium salt is not particularly limited, and thereof include examples a tetramethylammonium chloride, a tetraethylammonium chloride, a tetranormalpropylammonium chloride, a tetranormalbutylammonium chloride, a tetranormalhexylammonium chloride, and the like.

By introducing the above quaternary ammonium salt into the electrically conductive polymer solution in accordance with an embodiment of the present invention, the quaternary ammonium salt reacts with the above polythiophene (A) to be a quaternary ammonium ion, and thus a quaternary ammonium ion salt of the polythiophene (A) is prepared. The quaternary ammonium ion is not particularly limited, and examples thereof include a tetramethylammonium ion, a tetraethylammonium ion, a tetranormalpropylammonium ion, a tetranormalbutylammonium ion, a tetranormalhexylammonium ion, and the like.

The above compound (D) with which an ion pair is formable with a sulfonic acid group is preferably an alkali metal hydroxide, ammonia, or a primary, secondary, or tertiary organic amine compound having 1 to 16 carbon atoms in total, in order to provide an electrolytic capacitor which excels in having low ESR. Examples of the primary, secondary, and tertiary organic amine compounds each having 1 to 16 carbon atoms in total include methylamine, dimethylamine, trimethylamine, ethylamine, triethylamine, normal-propylamine, isopropylamine, normal-butylamine, hexylamine, ethanolamine, dimethylaminoethanol, methylaminoethanol, diethanolamine, N-methyldiethanolamine, triethanolamine, 3-amino-1,2-propanediol, 3-methylamino-1,2-propanediol, 3-dimethylamino-1,2-propanediol, 1,4-butanediamine, triisobutylamine, triisopentylamine, imidazole, N-methylimidazole, 1,2-dimethylimidazole, pyridine, picoline, and lutidine.

In a case where the electrically conductive polymer solution in accordance with the present embodiment contains the above compound (D), a polythiophene (A) including at least one structural unit selected from the group consisting of a structural unit represented by the above general formula (1) and a structural unit represented by the above general formula (2) partially or wholly interacts with a compound (F). This leads to formation of a polythiophene (A) which includes at least one structural unit selected from the group consisting of a structural unit represented by a general formula (1′) below and a structural unit represented by a general formula (2′) below. That is, a mixture of the above compound (D) and a polythiophene (A) including at least one structural unit selected from the group consisting of a structural unit represented by the above general formula (1) and a structural unit represented by the above general formula (2) is the same as a polythiophene (A) including at least one structural unit selected from the group consisting of a structural unit represented by the general formula (1′) and a structural unit represented by the general formula (2′).

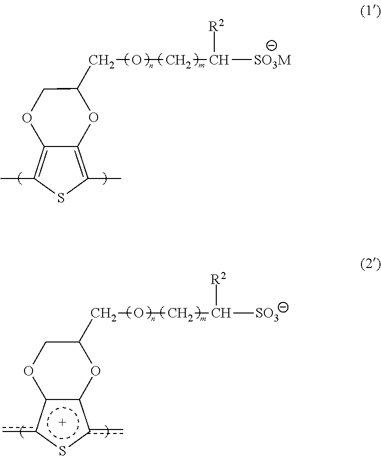

In the general formula (1′) and the general formula (2′), definitions and preferable ranges of R², m, and n are identical with the definitions and preferable ranges of R², m, and n indicated for the general formula (1) and the general formula (2). M represents a hydrogen ion, an alkali metal ion, an ammonium ion, an organic ammonium ion, or a quaternary ammonium ion.

The alkali metal ion, ammonium ion, organic ammonium ion, and quaternary ammonium ion in M above are as described above.

In the electrically conductive polymer solution in accordance with the present embodiment, a contained amount of the compound (D) with which an ion pair is formable with a sulfonic acid group is preferably 0.001% by mass to 20% by mass. In order to provide an electrolytic capacitor which exhibits a low ESR characteristic, the contained amount of the compound (D) is more preferably 0.01% by mass to 20% by mass, further preferably 0.1% by mass to 20% by mass.

The electrically conductive polymer solution in accordance with the present embodiment preferably contains sugar alcohol (E). The sugar alcohol (E) is not particularly limited, and examples thereof include erythritol, glycerin, lactitol, maltitol, xylitol, arabitol, mannitol, sorbitol, and the like. The sugar alcohol (E) used in the present embodiment can be used alone, or two or more of these can be used in combination. Note that a commercially available product can be used as it is as the sugar alcohol (E). Alternatively, a product which has been produced based on a commonly known method can be used as the sugar alcohol (E).

The sugar alcohol (E) is preferably mannitol, sorbitol, erythritol, xylitol, or lactitol. In order to provide an electrolytic capacitor which exhibits a low ESR characteristic, the sugar alcohol (E) is more preferably sorbitol or mannitol.

In the electrically conductive polymer solution in accordance with the present embodiment, a contained amount of the sugar alcohol (E) is preferably 0.001% by mass to 20% by mass. In order to provide an electrolytic capacitor which exhibits a low ESR characteristic, the contained amount of the sugar alcohol (E) is more preferably 0.01% by mass to 20% by mass, more preferably 0.1% by mass to 20% by mass, more preferably 1% by mass to 20% by mass, more preferably 3% by mass to 20% by mass, further preferably 7% by mass to 20% by mass, particularly preferably 12% by mass to 20% by mass.

In order to achieve excellent chemical stability, the electrically conductive polymer solution in accordance with the present embodiment preferably contains an electrically conductive polymer (F) which is a composite of a polyanion and a poly(3,4-ethylenedioxythiophene derivative) that includes a structural unit represented by a general formula (3) below.

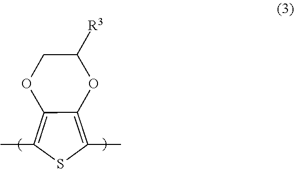

where R³ represents a hydrogen atom, an alkyl group having 1 to 6 carbon atoms, an alkyl group having a substituent and 1 to 6 carbon atoms, an alkoxy group having 1 to 6 carbon atoms, or an alkoxy group having a substituent and 1 to 6 carbon atoms.

The electrically conductive polymer (F) in accordance with the present embodiment is obtained by chemical oxidative polymerization of a 3,4-ethylenedioxythiophene derivative monomer in water in the presence of a polyanion.

In the general formula (3), R³ represents a hydrogen atom, an alkyl group having 1 to 6 carbon atoms, an alkyl group having a substituent and 1 to 6 carbon atoms, an alkoxy group having 1 to 6 carbon atoms, or an alkoxy group having a substituent and 1 to 6 carbon atoms.

In order to achieve excellent moisture resistance, R³ is preferably any one selected from the group consisting of a hydrogen atom, a methoxy group, an ethoxy group, a propoxy group, a butoxy group, and a hydroxymethyl group, more preferably a hydrogen atom or a hydroxymethyl group, further preferably a hydrogen atom.

The 3,4-ethylenedioxythiophene derivative monomer from which the structural unit represented by the general formula above is derived may be used alone for polymerization or mixed for polymerization. More preferably, 3,4-ethylenedioxythiophene is used alone.

The above polyanion is not particularly limited, and examples thereof include polystyrene sulfonic acid, polyvinyl sulfonic acid, polyallyl sulfonic acid, and the like, and metal salts, ammonium salts, amine salts, and the like of those. Among those, polystyrene sulfonic acid is preferably used to provide an electrolytic capacitor which exhibits a low ESR characteristic.

In order to provide an electrolytic capacitor which exhibits a low ESR characteristic, the electrically conductive polymer (F) is preferably a composite (hereafter referred to as “PEDOT:PSS”) constituted by poly(3,4-ethylenedioxythiophene) (PEDOT) and polystyrene sulfonic acid (PSS), and commercially available PEDOT:PSS can be used.

In the electrically conductive polymer solution in accordance with the present embodiment, a contained amount of the electrically conductive polymer (F) relative to 1 part by mass of the polythiophene (A) is preferably 0.001 parts by mass to 20 parts by mass, more preferably 0.1 parts by mass to 20 parts by mass, further preferably 1% by mass to 20% by mass.

The electrically conductive polymer solution in accordance with the present embodiment is not particularly limited, provided that the electrically conductive polymer solution contains water, and may contain a non-aqueous solvent. The non-aqueous solvent is not particularly limited, and may be an organic solvent, an electrolytic solution, or the like. In particular, an electrically conductive polymer solution in which the solvent is water is referred to also as an electrically conductive polymer aqueous solution.

Examples of the organic solvent include alcohol, an aprotic polar organic solvent, polyhydric alcohol, cyclic sulfones, lactones, and the like. Among those, lactones, polyhydric alcohol, and the like can be used also as an electrolytic solution.

It is preferable to use polyhydric alcohol as the organic solvent. Such a configuration brings about an advantage of making it possible to provide an electrolytic capacitor which exhibits a low initial surface resistance value (in other words, low ESR characteristic) and a high withstand voltage.

Examples of alcohol include methanol, ethanol, propanol, butanol, methoxyethanol, ethoxyethanol, butoxyethanol, ethylene glycol, and the like. Examples of the aprotic polar organic solvent dimethyl include sulfoxide, N,N-dimethylformamide, N,N-dimethylacetamide, 1-methyl-2-pyrrolidone, and the like. Examples of polyhydric alcohol include ethylene glycol, propylene glycol, polyglycerin, and the like. Examples of cyclic sulfones include sulfolane and the like. Examples of lactones include lactones such as y-butyrolactone.

The solvent may be a mixed solvent of water and alcohol and/or an aprotic polar organic solvent. In this case, a contained amount of alcohol and/or an aprotic polar organic solvent in the electrically conductive polymer solution is preferably 0.001% by mass to 20% by mass. In order to achieve excellent handleability, the contained amount of alcohol and/or an aprotic polar organic solvent is more preferably 0.01% by mass to 15% by mass, further preferably 0.1% by mass to 10% by mass.

The electrically conductive polymer solution in accordance with the present embodiment may contain a component (G) other than the above components.

The above component (G) is not particularly limited, and examples thereof include a binder, a surfactant, and the like.

The above binder is not particularly limited, and examples thereof include polyvinyl alcohol, polyvinylpyrrolidone, cellulose, a water-soluble polyester resin compound, a water-soluble polyurethane resin compound, a mixture of organic acid having two or more carboxyl groups, and the like.

Examples of the above water-soluble polyester resin compound include polyethylene terephthalate, polytrimethylene terephthalate, and the like. The water-soluble polyester resin compound may be a self-emulsifying type or be a forced-emulsifying type. From the viewpoint of water resistance and solvent resistance, it is preferable to employ a self-emulsifying water-soluble polyester resin compound.

As the above water-soluble polyester resin compound, for example, the following products are easily commercially available: VYLONAL (registered trademark) which is a product name and is available from Toyobo Co., Ltd.; PESRESIN (product name) available from TAKAMATSU OIL & FAT CO., LTD.; PLAS COAT (registered trademark) which is a product name and is available from GOO Chemical Co., Ltd.; ARON MELT (registered trademark) which is a product name and is available from TOAGOSEI CO., LTD.; PESRESIN A (product name) available from TAKAMATSU OIL & FAT CO., LTD.; and WATERSOL (registered trademark) which is a product name and is available from DIC Corporation.

It is possible to use one type of the above water-soluble polyester resin compounds alone, or it is possible to use two or more types of those as a mixture.

The above water-soluble polyurethane resin compound is used mainly in industrial applications as a urethane resin emulsion, and may be of a self-emulsifying type or be a forced-emulsifying type. From the viewpoint of water resistance and solvent resistance, it is preferable to employ a self-emulsifying water-soluble polyurethane resin compound. Examples of the self-emulsifying type include an anionic type, a cationic type, and a nonionic type. The self-emulsifying type may be any of those types. The water-soluble polyurethane resin compound is not particularly limited, and can be of a polyether type, a polyester type, a polycarbonate type, or the like.

As the water-soluble polyurethane resin compound, for example, the following products are easily commercially available: UCOAT (registered trademark), PERMARIN (registered trademark), and UPRENE (registered trademark) which are each a product name and available from Sanyo Chemical Industrial Co., Ltd.; NeoRez (registered trademark) which is a product name and is available from Kusumoto Chemicals, Ltd.; ADEKA BONTIGHTER (registered trademark) which is a product name and is available from ADEKA CORPORATION; Pascol (registered trademark) which is a product name and is available from Meisei Chemical Works, Ltd.; HYDRAN (registered trademark) which is a product name and is available from DIC Corporation; and the like.

It is possible to use one type of the above water-soluble polyurethane resin compounds alone, or it is possible to use two or more types of those as a mixture.

The above organic acid having two or more carboxyl groups is not particularly limited, and examples thereof include adipic acid, phthalic acid, and the like.

The above surfactant is not particularly limited, and examples thereof include an anionic surfactant, a cationic surfactant, a nonionic surfactant, an amphoteric surfactant, a fluorine-based surfactant, a silicone-based surfactant, and the like. The surfactant is more preferably at least one selected from the group consisting of a nonionic surfactant and an amphoteric surfactant.

The above anionic surfactant is not particularly limited, and examples thereof include sodium lauryl alcohol sulfate ester, or sodium dodecylbenzene sulfonate.

The above cationic surfactant is not particularly limited. A commercially available product can be used, or a commonly known product can be separately produced and used.

The above nonionic surfactant is not particularly limited, and examples thereof include a polyethylene glycol type surfactant, an acetylene glycol type surfactant, a polyhydric alcohol type surfactant, a high molecular type nonionic surfactant, and the like.

The above polyethylene glycol type surfactant is not particularly limited, and examples thereof include a higher alcohol ethylene oxide adduct, an alkylphenol ethylene oxide adduct, a fatty acid ethylene oxide adduct, a polyhydric alcohol fatty acid ester ethylene oxide adduct, a higher alkylamine ethylene oxide adduct, an ethylene oxide adduct of fat and oil, a polypropylene glycol ethylene oxide adduct, and the like.

The above acetylene glycol type surfactant is not particularly limited, and examples thereof include 2,4,7,9-tetramethyl-5-decyne-4,7-diol, SURFYNOL (registered trademark) (available from Air Products and Chemicals, Inc.), OLFINE (registered trademark) (available from Nissin Chemical Industry Co., Ltd.), and the like.

The above polyhydric alcohol type surfactant is not particularly limited, and examples thereof include: fatty acid ester of glycerol, fatty acid ester of pentaerythritol, fatty acid esters of sorbitol and sorbitan, fatty acid ester of sucrose, alkyl ether of high alcohol, fatty acid amides of alkanolamines, and the like.

The above amphoteric surfactant is not particularly limited, and examples thereof include a betaine-type amphoteric surfactant. The betaine-type amphoteric surfactant is not particularly limited, and examples thereof include alkyldimethylbetaine, lauryldimethylbetaine, stearyldimethylbetaine, lauryldihydroxyethylbetaine, and the like.

The above fluorine-based surfactant is not particularly limited, provided that the fluorine-based surfactant has a perfluoroalkyl group. Examples of the fluorine-based surfactant include PLAS COAT (registered trademark) RY-2, perfluoroalkane, perfluoroalkyl carboxylic acid, perfluoroalkyl sulfonic acid, a perfluoroalkyl ethylene oxide adduct, and the like.

The above silicone-based surfactant is not particularly limited, and examples thereof include polyether modified polydimethylsiloxane, polyether-ester modified polydimethylsiloxane, hydroxyl group-containing polyether modified polydimethylsiloxane, acrylic group-containing polyether modified polydimethylsiloxane, acrylic group-containing polyester modified polydimethylsiloxane, perfluoropolyether modified polydimethylsiloxane, perfluoropolyester modified polydimethylsiloxane, a silicone modified acrylic compound, and the like.

The fluorine-based surfactant or the silicone-based surfactant is effective as a leveling agent for improving flatness of a coating film.

In the electrically conductive polymer solution in accordance with the present embodiment, a contained amount of the foregoing component (G) is preferably 0.001% by mass to 20% by mass. In order to achieve excellent handleability, the contained amount is more preferably 0.01% by mass to 15% by mass, further preferably 0.1% by mass to 10% by mass.

A method for preparing the electrically conductive polymer solution in accordance with the present embodiment is not particularly limited, and examples thereof include a method in which: a solution or a solid of the polythiophene (A) in accordance with the present embodiment, the epoxy compound (B), and optionally the polyacrylic acid (C), the sugar alcohol (E), and the electrically conductive polymer (F), and water are mixed and uniformized by stirring, and the like. In the above method, it is possible to add the compound (D) with which an ion pair is formable with a sulfonic acid group and optionally other additives (e.g., the component (G), and the like) so as to adjust the mixture. Alternatively, it is possible that an electrically conductive polymer solution containing the polythiophene (A), the epoxy compound (B) and optionally the polyacrylic acid (C), the sugar alcohol (E), and the electrically conductive polymer (F) is prepared first, and is then mixed with the compound (D) with which an ion pair is formable with a sulfonic acid group and the above other additives for preparation.

Here, a temperature at the time of mixing is not particularly limited, and can be, for example, room temperature to warmed temperature. The temperature is preferably 0° C. or more and 100° C. or less.

An atmosphere in which mixing is carried out is not particularly limited, and the mixing can be carried out in air or in an inert gas.

In mixing the electrically conductive polymer solution in accordance with the present embodiment, in addition to a general mixing and dissolving operation with a stirrer tip or a mixing impeller, it is possible to carry out ultrasonic irradiation or a homogenization treatment (e.g., use of a mechanical homogenizer, an ultrasonic homogenizer, a high-pressure homogenizer, or the like). In the case of the homogenization treatment, it is preferable to carry out the homogenization treatment at low temperature to prevent thermal deterioration of the polymer.

A concentration of the electrically conductive polymer solution in accordance with the present embodiment may be adjusted by adjusting a compounding ratio, or may be adjusted by concentration after compounding. A method of concentration may be a method in which a solvent is evaporated under reduced pressure or may be a method in which an ultrafiltration membrane is used.

A contained amount of the polythiophene (A) in the electrically conductive polymer solution in accordance with the present embodiment is not particularly limited, provided that the contained amount is 0.01% by mass to 10% by mass. Note that the electrically conductive polymer solution containing the polythiophene (A) and the epoxy compound (B) in the present invention is dried and dehydrated after application. Therefore, it is possible to obtain a satisfactory uniform film by employing the above range of contained amount.

A particle diameter of a solid content in the electrically conductive polymer solution in accordance with the present embodiment is not particularly limited. A smaller particle diameter leads to better water solubility. From the viewpoint of electrical conductivity and uniformity in film formation, a smaller particle diameter is preferable. For example, in a case where a solid concentration of the electrically conductive polymer solution prepared at room temperature or under warming is 10% by mass or less, the particle diameter (D50) of the solid content is preferably 0.02 μm or less.

A viscosity (20° C.) of the electrically conductive polymer solution in accordance with the present embodiment is preferably 200 mPa·s or less, more preferably 100 mPa·s or less, further preferably 50 mPa·s or less.

The electrically conductive polymer film in accordance with the present embodiment can be formed using the electrically conductive polymer solution in accordance with the present embodiment. A method (production method) for forming the electrically conductive polymer film in accordance with the present embodiment is not particularly limited, and examples thereof include a method including the steps of: applying the electrically conductive polymer solution in accordance with the present embodiment to a base material; and drying the electrically conductive polymer solution.

A drying atmosphere can be either in air, in an inert gas, in vacuum, or under reduced pressure. From the viewpoint of inhibiting deterioration of a polymeric membrane, an inert gas such as nitrogen or argon is preferably used.

The above base material is not particularly limited, and examples thereof include glass, plastic, polyester, polyacrylate, polycarbonate, metal oxide, ceramics, a resist substrate, and the like.

The above application method is not particularly limited, and examples thereof include a casting method, a dipping method, a bar coating method, a roller coating method, a gravure coating method, a flexographic printing method, a spray coating method, a spin coating method, an inkjet printing method, and the like.

A drying temperature of the coating film is not particularly limited, provided that a uniform electrically conductive film is obtained at the temperature. The drying temperature falls within preferably a range of room temperature to 300° C., more preferably a range of room temperature to 250° C., further preferably a range of room temperature to 200° C. In this specification, room temperature is intended to be 15° C. to 25° C.

A film thickness of the coating film is not particularly limited, and is preferably in a range of 10⁻² μm to 10² μm. A surface resistivity of the resultant coating film is not particularly limited, and is preferably in a range of 1 to 10⁹ Ω/sq.

An electric conductivity of the electrically conductive polymer film obtained in the present embodiment is not particularly limited, and an electric conductivity in the form of film is preferably 10 S/cm or more.

The electrically conductive polymer film in accordance with the present embodiment can be used, for example, in an antistatic agent, a solid electrolyte of an electrolytic capacitor, an electrically conductive coating, an electrochromic element, an electrode material, a thermoelectric conversion material, a transparent electrically conductive film, a chemical sensor, an actuator, and the like. In particular, the electrically conductive polymer film is extremely useful as a solid electrolyte of an electrolytic capacitor. In a case where the electrically conductive polymer film in accordance with the present embodiment is used in an electrolytic capacitor, it is possible to provide an electrolytic capacitor which has an excellent characteristic of low ESR while maintaining a high capacity.

The electrically conductive polymer film in accordance with the present embodiment can provide an electrolytic capacitor and the like which have long lifetime, and can thus contribute to improvement in energy efficiency. Therefore, it is possible to contribute to achievement of the sustainable development goals (SDGs).

The electrolytic capacitor in accordance with the present embodiment can be formed using the electrically conductive polymer solution in accordance with the present embodiment. A method for producing the electrolytic capacitor in accordance with the present embodiment can be a method including the steps of: covering, with the electrically conductive polymer solution in accordance with the present embodiment, a surface of a dielectric oxide film which is formed in a positive electrode body; and drying the electrically conductive polymer solution by heating. More specifically, the method for producing the electrolytic capacitor in accordance with the present embodiment may be a method including the steps of: immersing an element including a positive electrode body and a negative electrode in the electrically conductive polymer solution in accordance with the present embodiment; and drying the electrically conductive polymer solution by heating.

In the present embodiment, the positive electrode body preferably includes a dielectric oxide film (dielectric layer) and a positive electrode. In other words, the dielectric layer is constituted by an oxide film.

In the present embodiment, the positive electrode is not particularly limited. From the viewpoint of easiness in formation of a dielectric layer, the positive electrode is preferably constituted by one or more materials selected from the group consisting of aluminum, tantalum, niobium, and titanium. The positive electrode is more preferably constituted by aluminum.

In the present embodiment, the oxide film which constitutes the dielectric layer is preferably generated by oxidation of a surface of the positive electrode. A method for forming the oxide film on the surface of the positive electrode (i.e., a method for producing a positive electrode body) is not particularly limited, and examples thereof include a method in which a positive electrode is oxidized by voltage application in a buffer solution, and the like.

In the present embodiment, the negative electrode is not particularly limited. From the viewpoint of easiness in formation of a dielectric layer, the negative electrode is preferably constituted by one or more materials selected from the group consisting of aluminum, silver, tantalum, niobium, and titanium. The negative electrode is more preferably constituted by aluminum.

As a drying temperature in the method for producing an electrolytic capacitor in accordance with the present embodiment, it is possible to apply the description of the drying temperature of the coating film in the method (production method) for forming an electrically conductive polymer film in accordance with the present embodiment.

Among the electrolytic capacitors in the present embodiment, a hybrid capacitor is obtained, for example, as follows: a solid electrolytic capacitor is obtained by the above described method, and then the solid electrolytic capacitor is immersed in an electrolytic solution.

A solvent used in the electrolytic solution which is used in producing a hybrid capacitor is not particularly limited. From the viewpoint of property of being difficult to evaporate even at high temperature, the solvent is preferably one or more selected from the group consisting of γ-butyrolactone, ethylene glycol, propylene glycol, sulfolane, N-methylacetamide, N,N-dimethylformamide, and N-methyl-2-pyrrolidone.

The present invention is not limited to the embodiments, but can be altered by a skilled person in the art within the scope of the claims. The present invention also encompasses, in its technical scope, any embodiment derived by combining technical means disclosed in differing embodiments.

Aspects of the present invention may include the following features.

<1> An electrically conductive polymer solution, containing: 0.01% by mass to 10% by mass of polythiophene (A) including at least one structural unit which is selected from the group consisting of a structural unit represented by a general formula (1) below and a structural unit represented by a general formula (2) below; 0.001% by mass to 20% by mass of an epoxy compound (B) having at least two epoxy groups; and water, a pH of the electrically conductive polymer solution being 1.5 to 5.0,

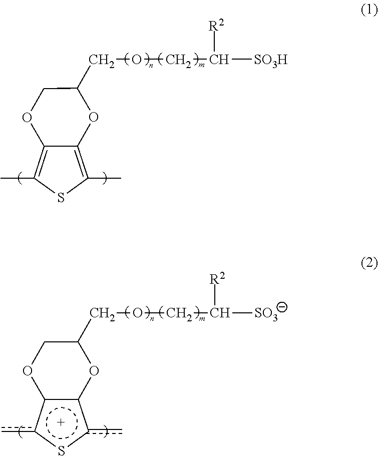

in the general formulae (1) and (2), R² represents a hydrogen atom, a methyl group, an ethyl group, a linear or branched alkyl group having 3 to 6 carbon atoms, or a fluorine atom, m represents an integer of 1 to 10, and n represents 0 or 1.

<2> The electrically conductive polymer solution described in <1>, further containing 0.001% by mass to 20% by mass of polyacrylic acid (C).

<3> The electrically conductive polymer solution described in <1> or <2>, further containing: 0.001% by mass to 20% by mass of a compound (D) with which an ion pair is formable with a sulfonic acid group of the polythiophene (A).

<4> The electrically conductive polymer solution described in any one of <1> through <3>, in which: a contained amount of the epoxy compound (B) is 0.1 parts by mass to 15 parts by mass, relative to 1 part by mass of the polythiophene (A).

<5> The electrically conductive polymer solution described in <2>, in which: a contained amount of the polyacrylic acid (C) is 0.1 parts by mass to 10 parts by mass, relative to 1 part by mass of the polythiophene (A).

<6> The electrically conductive polymer solution described in any one of <1> through <5>, further containing: 0.001% by mass to 20% by mass of sugar alcohol (E).

<7> The electrically conductive polymer solution described in <6>, in which: the sugar alcohol (E) is sorbitol, mannitol, erythritol, xylitol, or lactitol.

<8> The electrically conductive polymer solution described in any one of <1> through <7>, further containing: an electrically conductive polymer (F) which is a composite of a polyanion and a poly(3,4-ethylenedioxythiophene derivative) that includes a structural unit represented by a general formula (3) below, a contained amount of the electrically conductive polymer (F) being 0.001 parts by mass to 20 parts by mass, relative to 1 part by mass of the polythiophene (A),

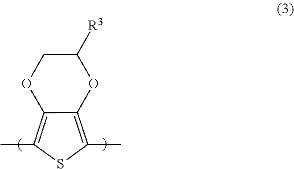

where R³ represents a hydrogen atom, an alkyl group having 1 to 6 carbon atoms, an alkyl group having a substituent and 1 to 6 carbon atoms, an alkoxy group having 1 to 6 carbon atoms, or an alkoxy group having a substituent and 1 to 6 carbon atoms.

<9> The electrically conductive polymer solution described in <8>, in which: R³ is a hydrogen atom.

<10> The electrically conductive polymer solution described in <8>, in which: the electrically conductive polymer (F) is PEDOT:PSS.

<11> A method for producing an electrically conductive polymer film, the method including the steps of: applying the electrically conductive polymer solution described in any one of <1> through <10> to a base material; and drying the electrically conductive polymer solution.

<12> A method for producing an electrolytic capacitor, the method including the steps of: covering, with the electrically conductive polymer solution described in any one of <1 > through <10>, a surface of a dielectric oxide film which is formed in a positive electrode body; and drying the electrically conductive polymer solution by heating.

### EXAMPLES

The following description will specifically discuss the present invention with reference to Examples. Note, however, that the present invention is not limited to these Examples.

Pieces of analytical equipment and measurement methods used in Examples are listed as follows.

### NMR Measurement

Device: Gemini-200 available from Varian Medical Systems, Inc.

### Electric Conductivity Measurement of Polythiophene (A)

To an alkali-free glass plate having a size of 25-mm square, 0.5 ml of an aqueous solution containing PEDOT-MPS (corresponding to the polythiophene (A) of the present invention) described later was applied. The aqueous solution was heated under air at 60° C. for 30 minutes on a hot plate, and additionally heated at 200° C. for 60 minutes, and thus an electrically conductive polymer film was obtained.

For the electrically conductive polymer film, a glass portion was exposed by slitting at intervals of 6.25 mm in the x-direction and 6.25 mm in the y-direction, and a film thickness was measured at nine measurement sites in an atmosphere at 25° C. and 50% RH. As a measurement device, DEKTAK XT available from BRUKER was used. Moreover, a surface resistivity was measured at the above nine measurement sites in an atmosphere at 25° C. and 50% RH. As a measurement device, a surface resistance measuring instrument LORESTA GP MCP-T600 available from Mitsubishi Chemical Corporation was used, and a measurement probe was ASP.

From the film thickness and surface resistivity of the electrically conductive polymer film measured by the above measurement method, an electric conductivity was calculated based on the following formula.

$$Electric conductivity [ S / cm ] = {10}^{4} / ( surface resistivity [ Ω / sq ] \times film thickness [ μm ] )$$

### Preparation of Solid Electrolytic Capacitor

A lead wire was attached, by welding, to a part of an aluminum foil which has been subjected to an etching treatment at a thickness of 100 μm (positive electrode). The aluminum foil subjected to the etching treatment was immersed in an aqueous solution of ammonium dihydrogen phosphate at a liquid temperature of 80° C. and having a concentration of 0.2 wt %, and a DC voltage of 130 V was applied for 20 minutes. Thus, a dielectric layer constituted by aluminum oxide (i.e., an oxide film of aluminum) was formed on a surface of the positive electrode (positive electrode body).

Separately, an aluminum foil which had a thickness of 50 μm, which had been subjected to an etching treatment, and to which a lead wire was attached was prepared as a negative electrode. A wound element was prepared which was wound and in which a separator constituted by an insulating paper was intervened between the positive electrode body and the negative electrode. Next, the wound element was immersed in an electrically conductive polymer solution (described later) and then taken out. Next, the wound element was dried at 150° C. for 30 minutes, and thus an unsealed solid electrolytic capacitor element was prepared.

### Preparation of Hybrid Capacitor

The solid electrolytic capacitor element prepared by the above method was immersed in a γ-butyrolactone-based electrolytic solution, and thus an unsealed hybrid capacitor element was obtained.

### Characteristic Measurement of Capacitor Element

Device: LCR meter IM3536 available from Hioki E.E. Corporation

As characteristics of the solid electrolytic capacitor element and the hybrid capacitor element prepared by the above described methods, an initial capacity [μF] at 120 Hz and an initial ESR [mΩ] at 100 kHz were evaluated using the above device.

Here, in a case where the initial capacity [μF] at 120 Hz was 103 μF or more, such a solid electrolytic capacitor was determined to be a “solid electrolytic capacitor having a high capacity”.

In a case where the initial ESR [mΩ] at 100 kHz was 12.0 mΩ or less, such a solid electrolytic capacitor was determined to be a “solid electrolytic capacitor exhibiting a low ESR characteristic”.

Furthermore, a capacity [μF] at 120 Hz and an ESR [mΩ] at 100 kHz were evaluated also for the above “hybrid capacitor element” which had been left at 260° C. for 10 minutes or left at 150° C. for 150 hours.

Note that the inventors have found that, in a case where a capacity [μF] at 120 Hz and an ESR [mΩ] at 100 kHz of the “hybrid capacitor element” after being left at 260° C. for 10 minutes are satisfactory values, a high capacity and a low ESR characteristic can be maintained for a long time (hundreds of hours) at a temperature (generally approximately 150° C.) lower than 260° C. Therefore, in these Examples, in a case where the “hybrid capacitor element” after being left at 260° C. for 10 minutes had an ESR [mΩ] at 100 kHz, measured by the method described above, of 20 mΩ or less or an ESR change rate (R/R₀) of 1.50 or less, the hybrid capacitor element was determined to be a “hybrid capacitor that can maintain a low ESR characteristic for a long time”. Moreover, in a case where the “hybrid capacitor element” after being left at 260° C. for 10 minutes had a capacity [μF] at 120 Hz, measured by the method described above, of 104 μF or more, the hybrid capacitor element was determined to be a “hybrid capacitor that can maintain a high capacity for a long time”.

Furthermore, the inventors have found that, in a case where a capacity [μF] at 120 Hz and an ESR [mΩ] at 100 kHz of the “hybrid capacitor element” after being left at 150° C. for 150 hours are satisfactory values, a high capacity and a low ESR characteristic can be maintained for a long time (hundreds of hours) at a temperature lower than 150° C. Therefore, in these Examples, in a case where the “hybrid capacitor element” after being left at 150° C. for 150 hours had an ESR [mΩ] at 100 kHz, measured by the method described above, of 20 mΩ or less or an ESR change rate (R/R₀) of 1.50 or less, the hybrid capacitor element was determined to be a “hybrid capacitor that can maintain a low ESR characteristic for a long time”. Moreover, in a case where the “hybrid capacitor element” after being left at 150° C. for 150 hours had a capacity [μF] at 120 Hz, measured by the method described above, of 104 μF or more, the hybrid capacitor element was determined to be a “hybrid capacitor that can maintain a high capacity for a long time”.

### Synthesis Example 1

An aqueous solution of poly(3-[(2,3-dihydrothieno[3,4-b]-[1,4]dioxin-2-yl)methoxy]-1-methyl-1-propanesulfonate) (hereafter referred to as “PEDOT-MPS”) was prepared in accordance with Synthesis Example 1 and Synthesis Example 2 disclosed in a known literature (Japanese Patent Application Publication Tokukai No. 2019-196443). The PEDOT-MPS is a polymer including structural units represented by formulae (5) and (6) below, and corresponds to the polythiophene (A) of the present invention. A concentration of the polythiophene (A) contained in the aqueous solution was 0.74% by mass. The aqueous solution contained 44 ppm of iron ions and 12 ppm of sodium ions, (relative to the polymer). An electric conductivity of the above PEDOT-MPS was 342 S/cm.

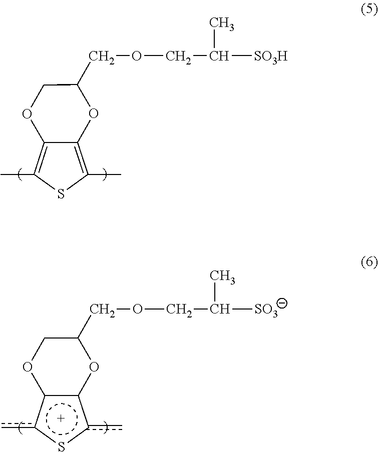

### Example 1

### Preparation of Electrically Conductive Polymer Solution

The aqueous solution of PEDOT-MPS obtained in Synthesis Example 1 was dehydrated by reducing pressure, and thus an aqueous solution containing 1.56% by mass of PEDOT-MPS was prepared. To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415), 1.0 g of ethyleneglycol diglycidyl ether (available from Tokyo Chemical Industry Co., Ltd.) as the epoxy compound (B), 20.0 g of polyglycerin (available from Sakamoto Yakuhin Kogyo Co., Ltd., Polyglycerin #310), and 10.5 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 2

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of ethyleneglycol diglycidyl ether (available from Tokyo Chemical Industry Co., Ltd.) as the epoxy compound (B), 20.0 g of polyglycerin (available from Sakamoto Yakuhin Kogyo Co., Ltd., Polyglycerin #310), and 9.45 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 3

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415), 1.0 g of glycerol diglycidyl ether (available from Sigma-Aldrich) as the epoxy compound (B), 20.0 g of polyglycerin (available from Sakamoto Yakuhin Kogyo Co., Ltd., Polyglycerin #310), and 10.5 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 4

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415), 2.0 g of glycerol diglycidyl ether (available from Sigma-Aldrich) as the epoxy compound (B), 20.0 g of polyglycerin (available from Sakamoto Yakuhin Kogyo Co., Ltd., Polyglycerin #310), and 9.45 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 5

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415), 2.0 g of sorbitol polyglycidyl ether (available from Nagase ChemteX Corporation, DENACOL EX-614B) as the epoxy compound (B), 20.0 g of polyglycerin (available from Sakamoto Yakuhin Kogyo Co., Ltd., Polyglycerin #310), and 9.45 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 6

A solid electrolytic capacitor element and a hybrid capacitor element were prepared in accordance with Example 4 except that, in Example 4, 0.3 g of 2-amino-2-hydroxymethyl-1,3-propanediol was added and mixed by stirring and then 300 g of a 1.2% PEDOT:PSS aqueous dispersion liquid was added and mixed by stirring. Then, characteristic evaluation was carried out. Evaluation results are shown in Tables 1, 3, and 5.

### Example 7

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415), 2.0 g of diglycerol polyglycidyl ether (available from Nagase ChemteX Corporation, DENACOL EX-421) as the epoxy compound (B), 20.0 g of polyglycerin (available from Sakamoto Yakuhin Kogyo Co., Ltd., Polyglycerin #310), and 9.45 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 8

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 5.0 g of ethyleneglycol diglycidyl ether (available from Tokyo Chemical Industry Co., Ltd.) as the epoxy compound (B), 20.0 g of polyglycerin (available from Sakamoto Yakuhin Kogyo Co., Ltd., Polyglycerin #310), and 6.45 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 9

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 10.0 g of ethyleneglycol diglycidyl ether (available from Tokyo Chemical Industry Co., Ltd.) as the epoxy compound (B), 20.0 g of polyglycerin (available from Sakamoto Yakuhin Kogyo Co., Ltd., Polyglycerin #310), and 1.45 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 10

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of ethyleneglycol diglycidyl ether (available from Tokyo Chemical Industry Co., Ltd.) as the epoxy compound (B), 5.00 g of sorbitol (available from FUJIFILM Wako Pure Chemical Corporation) as the sugar alcohol (E), 20.0 g of polyglycerin (available from Sakamoto Yakuhin Kogyo Co., Ltd., Polyglycerin #310), and 4.45 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 11

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of ethyleneglycol diglycidyl ether (available from Tokyo Chemical Industry Co., Ltd.) as the epoxy compound (B), 9.00 g of sorbitol (available from FUJIFILM Wako Pure Chemical Corporation) as the sugar alcohol (E), 20.0 g of polyglycerin (available from Sakamoto Yakuhin Kogyo Co., Ltd., Polyglycerin #310), and 0.45 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 12

To 50.0 g of the above aqueous solution containing 2.00% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of ethyleneglycol diglycidyl ether (available from Tokyo Chemical Industry Co., Ltd.) as the epoxy compound (B), 15.00 g of sorbitol (available from FUJIFILM Wako Pure Chemical Corporation) as the sugar alcohol (E), 20.0 g of polyglycerin (available from Sakamoto Yakuhin Kogyo Co., Ltd., Polyglycerin #310), and 8.56 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 13

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of ethyleneglycol diglycidyl ether (available from Tokyo Chemical Industry Co., Ltd.) as the epoxy compound (B), 9.00 g of mannitol (available from FUJIFILM Wako Pure Chemical Corporation) as the sugar alcohol (E), 20.0 g of polyglycerin (available from Sakamoto Yakuhin Kogyo Co., Ltd., Polyglycerin #310), and 0.45 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 14

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of ethyleneglycol diglycidyl ether (available from Tokyo Chemical Industry Co., Ltd.) as the epoxy compound (B), 9.00 g of erythritol (available from FUJIFILM Wako Pure Chemical Corporation) as the sugar alcohol (E), 20.0 g of polyglycerin (available from Sakamoto Yakuhin Kogyo Co., Ltd., Polyglycerin #310), and 0.45 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 15

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of ethyleneglycol diglycidyl ether (available from Tokyo Chemical Industry Co., Ltd.) as the epoxy compound (B), 9.00 g of xylitol (available from FUJIFILM Wako Pure Chemical Corporation) as the sugar alcohol (E), 20.0 g of polyglycerin (available from Sakamoto Yakuhin Kogyo Co., Ltd., Polyglycerin #310), and 0.45 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 16

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of ethyleneglycol diglycidyl ether (available from Tokyo Chemical Industry Co., Ltd.) as the epoxy compound (B), 9.00 g of lactitol (available from FUJIFILM Wako Pure Chemical Corporation) as the sugar alcohol (E), 20.0 g of polyglycerin (available from Sakamoto Yakuhin Kogyo Co., Ltd., Polyglycerin #310), and 0.45 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 17

To 64.1 g of the above aqueous solution containing 1.56% by mass of PEDOT-MPS, 2.0 g of ethyleneglycol diglycidyl ether (available from Tokyo Chemical Industry Co., Ltd.) as the epoxy compound (B), 20.0 g of polyglycerin (available from Sakamoto Yakuhin Kogyo Co., Ltd., Polyglycerin #310), and 0.13.9 g of water were added, and those components were mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 18

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of ethyleneglycol diglycidyl ether (available from Tokyo Chemical Industry Co., Ltd.) as the epoxy compound (B), 20.0 g of polyglycerin (available from Sakamoto Yakuhin Kogyo Co., Ltd., Polyglycerin #310), and 9.45 g of water were added, and those components were mixed by stirring. Next, to the obtained mixed solution, 0.25 g of 2-amino-2-hydroxymethyl-1,3-propanediol was added and mixed by stirring, and thus an electrically conductive polymer solution having a pH of 2 was obtained. An amount of 2-amino-2-hydroxymethyl-1,3-propanediol was 0.25 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Example 19

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of ethyleneglycol diglycidyl ether (available from Tokyo Chemical Industry Co., Ltd.) as the epoxy compound (B), 20.0 g of polyglycerin (available from Sakamoto Yakuhin Kogyo Co., Ltd., Polyglycerin #310), and 9.45 g of water were added, and those components were mixed by stirring. Next, to the obtained mixed solution, 0.4 g of 2-amino-2-hydroxymethyl-1,3-propanediol was added and mixed by stirring, and thus an electrically conductive polymer solution having a pH of 5 was obtained. An amount of 2-amino-2-hydroxymethyl-1,3-propanediol was 0.4 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 1, 3, and 5.

### Comparative Example 1

To 64.1 g of the above aqueous solution containing 1.56% by mass of PEDOT-MPS, 35.9 g of water was added and mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 2, 4, and 6.

### Comparative Example 2

To 83.3 g of a 1.2% by mass PEDOT:PSS aqueous dispersion liquid, 16.7 g of water was added and mixed by stirring. Next, to the obtained mixed solution, 0.3 g of 2-amino-2-hydroxymethyl-1,3-propanediol was added and mixed by stirring, and thus an electrically conductive polymer aqueous dispersion liquid having a pH of 3 was obtained. An amount of 2-amino-2-hydroxymethyl-1,3-propanediol was 0.3 parts by mass, relative to 1 part by mass of PEDOT:PSS. A solid electrolytic capacitor element and a hybrid capacitor element were prepared in accordance with the foregoing method using the electrically conductive polymer aqueous dispersion liquid, and characteristic evaluation was carried out. Evaluation results are shown in Tables 2, 4, and 6.

### Comparative Example 3

To 83.3 g of a 1.2% by mass PEDOT:PSS aqueous dispersion liquid, 2.0 g of ethyleneglycol diglycidyl ether (available from Tokyo Chemical Industry Co., Ltd.) as the epoxy compound (B) and 14.7 g of water were added and mixed by stirring. Next, to the obtained mixed solution, 0.3 g of 2-amino-2-hydroxymethyl-1,3-propanediol was added and mixed by stirring, and thus an electrically conductive polymer aqueous dispersion liquid having a pH of 3 was obtained. An amount of 2-amino-2-hydroxymethyl-1,3-propanediol was 0.3 parts by mass, relative to 1 part by mass of PEDOT:PSS. A solid electrolytic capacitor element and a hybrid capacitor element were prepared in accordance with the foregoing method using the electrically conductive polymer aqueous dispersion liquid, and characteristic evaluation was carried out. Evaluation results are shown in Tables 2, 4, and 6.

### Comparative Example 4

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of 3-glycidyloxypropyltrimethoxysilane (available from Tokyo Chemical Industry Co., Ltd., monoepoxy compound), 20.0 g of polyglycerin (available from Sakamoto Yakuhin Kogyo Co., Ltd., Polyglycerin #310), and 9.45 g of water were added and mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 2, 4, and 6.

### Comparative Example 5

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of lauryl alcohol (EO)₁₅ glycidyl ether (available from Nagase ChemteX Corporation, DENACOL EX-171, monoepoxy compound), 20.0 g of polyglycerin (available from Sakamoto Yakuhin Kogyo Co., Ltd., Polyglycerin #310), and 9.45 g of water were added and mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 2, 4, and 6.

### Comparative Example 6

To 64.1 g of the above aqueous solution containing 1.56% by mass of PEDOT-MPS, 2.0 g of lauryl alcohol (EO)₁₅ glycidyl ether (available from Nagase ChemteX Corporation, DENACOL EX-171, monoepoxy compound), 20.0 g of polyglycerin (available from Sakamoto Yakuhin Kogyo Co., Ltd., Polyglycerin #310), and 13.9 g of water were added and mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 2, 4, and 6.

### Comparative Example 7

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of phenol (EO)₅ glycidyl ether (available from Nagase ChemteX Corporation, DENACOL EX-145, monoepoxy compound), 20.0 g of polyglycerin (available from Sakamoto Yakuhin Kogyo Co., Ltd., Polyglycerin #310), and 9.45 g of water were added and mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 2, 4, and 6.

### Comparative Example 8

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of 1,2-epoxybutane (available from FUJIFILM Wako Pure Chemical Corporation, monoepoxy compound), 20.0 g of polyglycerin (available from Sakamoto Yakuhin Kogyo Co., Ltd., Polyglycerin #310), and 9.45 g of water were added and mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 2, 4, and 6.

### Comparative Example 9

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of 2,3-epoxy-1-propanol (available from FUJIFILM Wako Pure Chemical Corporation, monoepoxy compound), 20.0 g of polyglycerin (available from Sakamoto Yakuhin Kogyo Co., Ltd., Polyglycerin #310), and 9.45 g of water were added and mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 2, 4, and 6.

### Comparative Example 10

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of ethyleneglycol diglycidyl ether (available from Tokyo Chemical Industry Co., Ltd.) as the epoxy compound (B), 20.0 g of polyglycerin (available from Sakamoto Yakuhin Kogyo Co., Ltd., Polyglycerin #310), and 9.45 g of water were added, and those components were mixed by stirring, and thus an electrically conductive polymer solution having a pH of 1.2 was obtained. A solid electrolytic capacitor element and a hybrid capacitor element were prepared in accordance with the foregoing method using the electrically conductive polymer solution, and characteristic evaluation was carried out. Evaluation results are shown in Tables 2, 4, and 6.

### Comparative Example 11

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of ethyleneglycol diglycidyl ether (available from Tokyo Chemical Industry Co., Ltd.) as the epoxy compound (B), 20.0 g of polyglycerin (available from Sakamoto Yakuhin Kogyo Co., Ltd., Polyglycerin #310), and 9.45 g of water were added, and those components were mixed by stirring. Next, to the obtained mixed solution, 0.55 g of 2-amino-2-hydroxymethyl-1,3-propanediol was added and mixed by stirring, and thus an electrically conductive polymer solution having a pH of 7 was obtained. An amount of 2-amino-2-hydroxymethyl-1,3-propanediol was 0.55 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 2, 4, and 6.

### Comparative Example 12

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 2.0 g of ethyleneglycol diglycidyl ether (available from Tokyo Chemical Industry Co., Ltd.) as the epoxy compound (B), 20.0 g of polyglycerin (available from Sakamoto Yakuhin Kogyo Co., Ltd., Polyglycerin #310), and 9.45 g of water were added, and those components were mixed by stirring. Next, to the obtained mixed solution, 0.9 g of 2-amino-2-hydroxymethyl-1,3-propanediol was added and mixed by stirring, and thus an electrically conductive polymer solution having a pH of 10 was obtained. An amount of 2-amino-2-hydroxymethyl-1,3-propanediol was 0.9 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 2, 4, and 6.

### Comparative Example 13

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 4.0 g of lauryl alcohol (EO)₁₅ glycidyl ether (available from Nagase ChemteX Corporation, DENACOL EX-171, monoepoxy compound), 20.0 g of polyglycerin (available from Sakamoto Yakuhin Kogyo Co., Ltd., Polyglycerin #310), and 7.45 g of water were added and mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 2, 4, and 6.

### Comparative Example 14

To 64.1 g of the above aqueous solution containing 1.56% by mass of PEDOT-MPS, 4.44 g of a 45% polyacrylic acid aqueous solution (available from Nippon Shokubai Co., Ltd., AQUALIC HL415 (weight average molecular weight: 10000)), 10.0 g of lauryl alcohol (EO)₁₅ glycidyl ether (available from Nagase ChemteX Corporation, DENACOL EX-171, monoepoxy compound), 20.0 g of polyglycerin (available from Sakamoto Yakuhin Kogyo Co., Ltd., Polyglycerin #310), and 1.45 g of water were added and mixed by stirring. Next, to the obtained mixed solution, 0.3 g of 2-amino-2-hydroxymethyl-1,3-propanediol was added and mixed by stirring, and thus an electrically conductive polymer solution having a pH of 3 was obtained. An amount of 2-amino-2-hydroxymethyl-1,3-propanediol was 0.3 parts by mass, relative to 1 part by mass of PEDOT-MPS. A solid electrolytic capacitor element and a hybrid capacitor element were prepared in accordance with the foregoing method using the electrically conductive polymer solution, and characteristic evaluation was carried out. Evaluation results are shown in Tables 2, 4, and 6.

TABLE 1

| | | | Added | Added amount | | | | |
|---|---|---|---|---|---|---|---|---|
| | | | amount | of polyacrylic | Sugar | | Capacity of solid | ESR of solid |
| | Electrically | | of (B) | acid (C) | alcohol (E) | | electrolytic | electrolytic |
| | conductive | | [% by | [% by | [added | | capacitor | capacitor |
| | polymer | Epoxy compound (B) | mass] | mass] | amount] | pH | [μF/120 Hz] | [mΩ/100 kHz] |
| Example 1 | PEDOT-MPS | Ethyleneglycol | 1 | 2 | None | 3.0 | 106 | 10.7 |
| | | diglycidyl ether | | | | | | |
| Example 2 | PEDOT-MPS | Ethyleneglycol | 2 | 2 | None | 3.0 | 105 | 10.6 |
| | | diglycidyl ether | | | | | | |
| Example 3 | PEDOT MPS | Glycerol diglycidyl | 1 | 2 | None | 3.0 | 105 | 10.6 |
| | | ether | | | | | | |
| Example 4 | PEDOT-MPS | Glycerol diglycidyl | 2 | 2 | None | 3.0 | 105 | 10.6 |
| | | ether | | | | | | |
| Example 5 | PEDOT-MPS | Sorbitol polyglycidyl | 2 | 2 | None | 3.0 | 105 | 9.6 |
| | | ether | | | | | | |
| Example 6 | PEDOT-MPS + | Glycerol diglycidyl | 2 | 2 | None | 3.0 | 105 | 9.1 |
| | PEDOT.PSS | ether | | | | | | |
| Example 7 | PEDOT-MPS | Diglycerol polyglycidyl | 2 | 2 | None | 3.0 | 106 | 10.9 |
| | | ether | | | | | | |
| Example 8 | PEDOT-MPS | Ethyleneglycol | 5 | 2 | None | 3.0 | 104 | 9.3 |
| | | diglycidyl ether | | | | | | |
| Example 9 | PEDOT-MPS | Ethyleneglycol | 10 | 2 | None | 3.0 | 103 | 9.0 |
| | | diglycidyl ether | | | | | | |
| Example 10 | PEDOT-MPS | Ethyleneglycol | 2 | 2 | Sorbitol [5% by | 3.0 | 105 | 9.3 |
| | | diglycidyl ether | | | mass] | | | |
| Example 11 | PEDOT-MPS | Ethyleneglycol | 2 | 2 | Sorbitol [9% by | 3.0 | 105 | 9.0 |
| | | diglycidyl ether | | | mass] | | | |
| Example 12 | PEDOT-MPS | Ethyleneglycol | 2 | 2 | Sorbitol [18% by | 3.0 | 104 | 8.7 |
| | | diglycidyl ether | | | mass] | | | |
| Example 13 | PEDOT-MPS | Ethyleneglycol | 2 | 2 | Mannitol [9% by | 3.0 | 104 | 9.5 |
| | | diglycidyl ether | | | mass] | | | |
| Example 14 | PEDOT-MPS | Ethyleneglycol | 2 | 2 | Erythritol [9% by | 3.0 | 105 | 10.2 |
| | | diglycidyl ether | | | mass] | | | |
| Example 15 | PEDOT-MPS | Ethyleneglycol | 2 | 2 | Xylitol [9% by | 3.0 | 105 | 10.0 |
| | | diglycidyl ether | | | mass] | | | |
| Example 16 | PEDOT-MPS | Ethyleneglycol | 2 | 2 | Lactitol [9% by | 3.0 | 105 | 9.8 |
| | | diglycidyl ether | | | mass] | | | |
| Example 17 | PEDOT-MPS | Ethyleneglycol | 2 | 0 | None | 3.0 | 106 | 10.8 |
| | | diglycidyl ether | | | | | | |
| Example 18 | PEDOT-MPS | Ethyleneglycol | 2 | 2 | None | 2.0 | 106 | 10.8 |
| | | diglycidyl ether | | | | | | |
| Example 19 | PEDOT-MPS | Ethyleneglycol | 2 | 2 | None | 5.0 | 105 | 11.0 |
| | | diglycidyl ether | | | | | | |

TABLE 2

| | | | Added | Added amount | | | | |
|---|---|---|---|---|---|---|---|---|
| | | | amount | of polyacrylic | Sugar | | Capacity of solid | ESR of solid |
| | Electrically | | of (B) | acid (C) | alcohol (E) | | electrolytic | electrolytic |
| | conductive | | [% by | [% by | [added | | capacitor | capacitor |
| | polymer | Epoxy compound (B) | mass] | mass] | amount] | pH | [μF/120 Hz] | [mΩ/100 kHz] |
| Comparative | PEDOT-MPS | None | 0 | 0 | None | 3.0 | 102 | 17.3 |
| Example 1 | | | | | | | | |
| Comparative | PEDOT.PSS | None | 0 | 0 | None | 3.0 | 93 | 16.0 |
| Example 2 | | | | | | | | |
| Comparative | PEDOT.PSS | Ethyleneglycol diglycidyl | 2 | 0 | None | 3.0 | 90 | 14.0 |
| Example 3 | | ether | | | | | | |
| Comparative | PEDOT-MPS | (3-glycidyloxypropyl | 2 | 2 | None | 3.0 | 102 | 11.0 |
| Example 4 | | trimethoxysilane) | | | | | | |
| Comparative | PEDOT-MPS | (Lauryl alcohol (EO)₁₅ | 2 | 2 | None | 3.0 | 100 | 10.5 |
| Example 5 | | glycidyl ether) | | | | | | |
| Comparative | PEDOT-MPS | (Lauryl alcohol (EO)₁₅ | 2 | 0 | None | 3.0 | 102 | 12.5 |
| Example 6 | | glycidyl ether) | | | | | | |
| Comparative | PEDOT-MPS | (Phenol (EO)₅ glycidyl ether) | 2 | 2 | None | 3.0 | 101 | 10.8 |
| Example 7 | | | | | | | | |
| Comparative | PEDOT-MPS | (1,2-epoxybutane) | 2 | 2 | None | 3.0 | 101 | 10.4 |
| Example 8 | | | | | | | | |
| Comparative | PEDOT-MPS | (2,3-epoxy-1-propanol) | 2 | 2 | None | 3.0 | 100 | 10.9 |
| Example 9 | | | | | | | | |
| Comparative | PEDOT-MPS | Ethyleneglycol diglycidyl | 2 | 2 | None | 1.2 | 100 | 18.2 |
| Example 10 | | ether | | | | | | |
| Comparative | PEDOT-MPS | Ethyleneglycol diglycidyl | 2 | 2 | None | 7.0 | 95 | 22.2 |
| Example 11 | | ether | | | | | | |
| Comparative | PEDOT-MPS | Ethyleneglycol diglycidyl | 2 | 2 | None | 10.0 | 90 | 63.4 |
| Example 12 | | ether | | | | | | |
| Comparative | PEDOT-MPS | (Lauryl alcohol (EO)₁₅ | 4 | 2 | None | 3.0 | 102 | 11.3 |
| Example 13 | | glycidyl ether) | | | | | | |
| Comparative | PEDOT-MPS | (Lauryl alcohol (EO)₁₅ | 10 | 2 | None | 3.0 | 94 | 16.3 |
| Example 14 | | glycidyl ether) | | | | | | |

TABLE 3

| | | | Capacity of | ESR (R) of | |
|---|---|---|---|---|---|
| | Initial | Initial ESR | hybrid | hybrid | |
| | capacity of | (R₀) of | capacitor at | capacitor at | ESR |
| | hybrid | hybrid | 260° C. after | 260° C. after | change |
| | capacitor | capacitor | 10 min | 10 min | rate |
| | [μF/120 Hz] | [mΩ/100 kHz] | [μF/120 Hz] | [mΩ/100 kHz] | (R/R₀) |
| Example 1 | 105 | 11.9 | 105 | 13.1 | 1.10 |
| Example 2 | 105 | 10.9 | 104 | 12.1 | 1.11 |
| Example 3 | 106 | 10.8 | 105 | 11.3 | 1.05 |
| Example 4 | 106 | 11.2 | 105 | 12.5 | 1.12 |
| Example 5 | 107 | 9.0 | 106 | 10.0 | 1.11 |
| Example 6 | 107 | 8.5 | 106 | 9.7 | 1.14 |
| Example 7 | 105 | 11.0 | 105 | 13.0 | 1.18 |
| Example 8 | 106 | 10.1 | 106 | 11.7 | 1.16 |
| Example 9 | 106 | 10.0 | 106 | 11.7 | 1.17 |
| Example 10 | 106 | 10.3 | 106 | 11.3 | 1.10 |
| Example 11 | 105 | 9.9 | 106 | 11.0 | 1.11 |
| Example 12 | 105 | 9.2 | 106 | 10.4 | 1.13 |
| Example 13 | 106 | 9.0 | 107 | 10.0 | 1.11 |
| Example 14 | 105 | 10.5 | 106 | 11.9 | 1.13 |
| Example 15 | 106 | 10.1 | 106 | 11.8 | 1.17 |
| Example 16 | 104 | 10.4 | 104 | 12.4 | 1.19 |
| Example 17 | 107 | 11.2 | 106 | 13.8 | 1.23 |
| Example 18 | 107 | 10.9 | 106 | 12.3 | 1.13 |
| Example 19 | 106 | 11.2 | 106 | 13.1 | 1.17 |

TABLE 4

| | | | Capacity of | ESR (R) of | |
|---|---|---|---|---|---|
| | | | hybrid | hybrid | |
| | Initial capacity | Initial ESR | capacitor at | capacitor at | ESR |
| | of hybrid | (R₀) of hybrid | 260° C. after | 260° C. after | change |
| | capacitor | capacitor | 10 min | 10 min | rate |
| | [μF/120 Hz] | [mΩ/100 kHz] | [μF/120 Hz] | [mΩ/100 kHz] | (R/R₀) |
| Comparative | 102 | 16.2 | 90 | 25.1 | 1.55 |
| Example 1 | | | | | |
| Comparative | 106 | 14.1 | 105 | 24.1 | 1.71 |
| Example 2 | | | | | |
| Comparative | 105 | 13.2 | 104 | 23.2 | 1.76 |
| Example 3 | | | | | |
| Comparative | 104 | 10.8 | 104 | 16.6 | 1.54 |
| Example 4 | | | | | |
| Comparative | 105 | 10.4 | 104 | 15.7 | 1.51 |
| Example 5 | | | | | |
| Comparative | 102 | 13.3 | 99 | 22.5 | 1.69 |
| Example 6 | | | | | |
| Comparative | 104 | 10.6 | 102 | 16.2 | 1.53 |
| Example 7 | | | | | |
| Comparative | 105 | 10.5 | 104 | 15.9 | 1.51 |
| Example 8 | | | | | |
| Comparative | 105 | 10.6 | 103 | 16.1 | 1.52 |
| Example 9 | | | | | |
| Comparative | 102 | 18.6 | 102 | 28.8 | 1.55 |
| Example 10 | | | | | |
| Comparative | 98 | 22.0 | 94 | 35.0 | 1.59 |
| Example 11 | | | | | |
| Comparative | 92 | 62.8 | 84 | 130.6 | 2.08 |
| Example 12 | | | | | |
| Comparative | 104 | 11.0 | 103 | 16.6 | 1.51 |
| Example 13 | | | | | |
| Comparative | 99 | 15.8 | 97 | 26.2 | 1.66 |
| Example 14 | | | | | |

TABLE 5

| | | | Capacity of | ESR (R₁) of | |
|---|---|---|---|---|---|
| | Initial | | hybrid | hybrid | |
| | capacity of | Initial ESR | capacitor at | capacitor at | ESR |
| | hybrid | (R₀) of hybrid | 150° C. after | 150° C. after | change |
| | capacitor | capacitor | 150 hours | 150 hours | rate |
| | [μF/120 Hz] | [mΩ/100 kHz] | [μF/120 Hz] | [mΩ/100 kHz] | (R₁/R₀) |
| Example 1 | 105 | 11.9 | 105 | 13.4 | 1.13 |
| Example 2 | 105 | 10.9 | 104 | 12.5 | 1.15 |
| Example 3 | 106 | 10.8 | 104 | 11.8 | 1.09 |
| Example 4 | 106 | 11.2 | 106 | 13.6 | 1.21 |
| Example 5 | 107 | 9.0 | 106 | 11.2 | 1.24 |
| Example 6 | 107 | 8.5 | 106 | 10.5 | 1.24 |
| Example 7 | 105 | 11.0 | 105 | 13.5 | 1.23 |
| Example 8 | 106 | 10.1 | 105 | 12.1 | 1.20 |
| Example 9 | 106 | 10.0 | 106 | 12.0 | 1.20 |
| Example 10 | 106 | 10.3 | 105 | 11.9 | 1.16 |
| Example 11 | 105 | 9.9 | 106 | 11.2 | 1.13 |
| Example 12 | 105 | 9.2 | 106 | 10.8 | 1.17 |
| Example 13 | 106 | 9.0 | 105 | 10.9 | 1.21 |
| Example 14 | 105 | 10.5 | 105 | 12.9 | 1.23 |
| Example 15 | 106 | 10.1 | 105 | 12.6 | 1.25 |
| Example 16 | 104 | 10.4 | 104 | 13.5 | 1.30 |
| Example 17 | 107 | 11.2 | 106 | 15.8 | 1.41 |
| Example 18 | 107 | 10.9 | 106 | 12.6 | 1.16 |
| Example 19 | 106 | 11.2 | 106 | 13.6 | 1.21 |

TABLE 6

| | | | Capacity of | ESR (R₁) of | |
|---|---|---|---|---|---|
| | | | hybrid | hybrid | |
| | Initial capacity | Initial ESR (R₀) | capacitor at | capacitor at | ESR |
| | of hybrid | of hybrid | 150° C. after | 150° C. after | change |
| | capacitor | capacitor | 150 hours | 150 hours | rate |
| | [μF/120 Hz] | [mΩ/100 kHz] | [μF/120 Hz] | [mΩ/100 kHz] | (R₁/R₀) |
| Comparative | 102 | 16.2 | 88 | 60.2 | 3.72 |
| Example 1 | | | | | |
| Comparative | 106 | 14.1 | 100 | 50.4 | 3.57 |
| Example 2 | | | | | |
| Comparative | 105 | 13.2 | 100 | 40.2 | 3.05 |
| Example 3 | | | | | |
| Comparative | 104 | 10.8 | 101 | 32.5 | 3.01 |
| Example 4 | | | | | |
| Comparative | 105 | 10.4 | 103 | 30.4 | 2.92 |
| Example 5 | | | | | |
| Comparative | 102 | 13.3 | 104 | 50.1 | 3.77 |
| Example 6 | | | | | |
| Comparative | 104 | 10.6 | 102 | 31.7 | 2.99 |
| Example 7 | | | | | |
| Comparative | 105 | 10.5 | 101 | 31.1 | 2.96 |
| Example 8 | | | | | |
| Comparative | 105 | 10.6 | 100 | 32.1 | 3.03 |
| Example 9 | | | | | |
| Comparative | 102 | 18.6 | 99 | 37.6 | 2.02 |
| Example 10 | | | | | |
| Comparative | 98 | 22.0 | 92 | 81.0 | 3.68 |
| Example 11 | | | | | |
| Comparative | 92 | 62.8 | 77 | 558.3 | 8.89 |
| Example 12 | | | | | |
| Comparative | 104 | 11.0 | 101 | 33.7 | 3.06 |
| Example 13 | | | | | |
| Comparative | 99 | 15.8 | 92 | 50.9 | 3.22 |
| Example 14 | | | | | |

From the results shown in Tables 1 and 2, Examples 1 through 19 using the electrically conductive polymer solution in accordance with the present embodiment could, by containing the epoxy compound (B), bring about an effect of making it possible to provide a solid electrolytic capacitor which has a high capacity and exhibits a low ESR characteristic.

From the results shown in Tables 3 and 4, Examples 1 through 19 could bring about an effect of making it possible to suppress a decrease in capacity and an increase in ESR of the hybrid capacitor after being left at 260° C. for 10 minutes. Furthermore, from the results shown in Tables 5 and 6, Examples 1 through 19 could bring about an effect of making it possible to maintain a high capacity and a low ESR characteristic of the hybrid capacitor for a long time, even after being left at 150° C. for 150 hours. It is inferred that the effects are brought about because elution of the electrically conductive polymer film into the electrolytic solution was suppressed by the epoxy compound (B). In contrast, Comparative Examples 1 through 3 could not achieve both a high capacity and a low ESR characteristic of the hybrid capacitor. As shown in Comparative Examples 10 through 12, in a case where the pH was not 1.5 to 5.0, a high capacity and a low ESR characteristic of the hybrid capacitor could not be concurrently achieved. Comparative Examples 4 through 9, 13, and 14 show the results of using a monoepoxy compound, and a high capacity and a low ESR characteristic of the hybrid capacitor could not be concurrently achieved. It is inferred that this is because a cross-linked structure is not formed because the monoepoxy compound is a monoepoxy body.

From the results shown in Tables 1 and 2, Examples 10 through 16 brought about, by containing the sugar alcohol (E), an effect of making it possible to further reduce the ESR of the solid electrolytic capacitor.

### INDUSTRIAL APPLICABILITY

As described above, by using the electrically conductive polymer solution in accordance with the present embodiment, it is possible to provide an electrolytic capacitor which has a higher capacity and exhibits a lower ESR characteristic, as compared with a case of using a conventional electrically conductive polymer solution.

1. An electrically conductive polymer solution, comprising:
0.01% by mass to 10% by mass of polythiophene (A) including at least one structural unit which is selected from the group consisting of a structural unit represented by a general formula (1) below and a structural unit represented by a general formula (2) below;
0.001% by mass to 20% by mass of an epoxy compound (B) having at least two epoxy groups; and
water,
a pH of said electrically conductive polymer solution being 1.5 to 5.0, 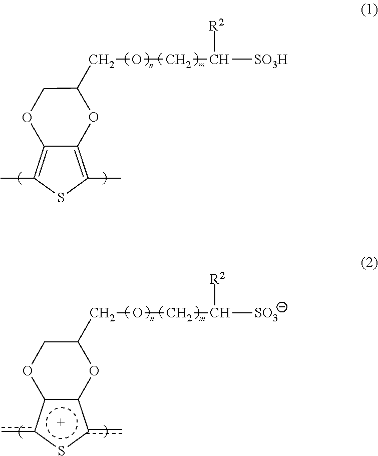
in the general formulae (1) and (2), R² represents a hydrogen atom, a methyl group, an ethyl group, a linear or branched alkyl group having 3 to 6 carbon atoms, or a fluorine atom, m represents an integer of 1 to 10, and n represents 0 or 1.

2. The electrically conductive polymer solution as set forth in claim 1, further comprising 0.001% by mass to 20% by mass of polyacrylic acid (C).

3. The electrically conductive polymer solution as set forth in claim 1, further comprising:
0.001% by mass to 20% by mass of a compound (D) with which an ion pair is formable with a sulfonic acid group of the polythiophene (A).

4. The electrically conductive polymer solution as set forth in claim 1, wherein:
a contained amount of the epoxy compound (B) is 0.1 parts by mass to 15 parts by mass, relative to 1 part by mass of the polythiophene (A).

5. The electrically conductive polymer solution as set forth in claim 2, wherein:
a contained amount of the polyacrylic acid (C) is 0.1 parts by mass to 10 parts by mass, relative to 1 part by mass of the polythiophene (A).

6. The electrically conductive polymer solution as set forth in claim 1, further comprising:
0.001% by mass to 20% by mass of sugar alcohol (E).

7. The electrically conductive polymer solution as set forth in claim 6, wherein:
the sugar alcohol (E) is sorbitol, mannitol, erythritol, xylitol, or lactitol.

8. The electrically conductive polymer solution as set forth in claim 1, further comprising:
an electrically conductive polymer (F) which is a composite of a polyanion and a poly(3,4-ethylenedioxythiophene derivative) that includes a structural unit represented by a general formula (3) below,
a contained amount of the electrically conductive polymer (F) being 0.001 parts by mass to 20 parts by mass, relative to 1 part by mass of the polythiophene (A), 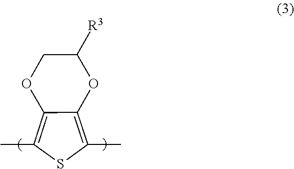
where R³ represents a hydrogen atom, an alkyl group having 1 to 6 carbon atoms, an alkyl group having a substituent and 1 to 6 carbon atoms, an alkoxy group having 1 to 6 carbon atoms, or an alkoxy group having a substituent and 1 to 6 carbon atoms.

9. The electrically conductive polymer solution as set forth in claim 8, wherein:
R³ is a hydrogen atom.

10. The electrically conductive polymer solution as set forth in claim 8, wherein:
the electrically conductive polymer (F) is PEDOT:PSS.

11. A method for producing an electrically conductive polymer film, said method comprising:
applying an electrically conductive polymer solution recited in claim 1 to a base material; and
drying the electrically conductive polymer solution.

12. A method for producing an electrolytic capacitor, said method comprising:
covering, with an electrically conductive polymer solution recited in claim 1, a surface of a dielectric oxide film which is formed in a positive electrode body; and
drying the electrically conductive polymer solution by heating.
